(19) United States
(12) Patent Application Publication
(10) Pub. No.: US 2010/0146341 A1
(43) Pub. Date: Jun. 10, 2010

(54) DRIVER DETECTING SYSTEM AND METHOD

(75) Inventors: SHEN-AN CHEN, Tu-Cheng (TW); YOU-REN LIN, Tu-Cheng (TW); RONG-CONG HUNG, Tu-Cheng (TW); SHIH-CHANG CHEN, Tu-Cheng (TW); RONG-HWANG HORNG, Tu-Cheng (TW); YAW-SHEN LAI, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/339,062

(22) Filed: Dec. 19, 2008

(30) Foreign Application Priority Data
Dec. 4, 2008 (CN) 200810305955.2

(51) Int. Cl. G06F 11/36

(52) U.S. Cl. 714/38; 714/E11.217

(57) ABSTRACT

A detecting system for detecting functions of a driver includes a storage unit, a control unit, and an human machine interface (HMI). The control unit samples a plurality of functions of the driver to generate a plurality of sampled values at each preset sampling time. The control unit determines if the plurality of sampled values are normal according to a plurality of preset reference ranges for the plurality of functions stored in the storage unit. When one or more of the plurality of sampled values is abnormal, the control unit generates an alarm signal, and the HMI displays the plurality of sampled values.

### BACKGROUND

1. Technical Field

The present disclosure relates to detecting systems and methods and, particularly, to a detecting system and a method for detecting a plurality of functions of a driver.

2. Description of Related Art

In various driving systems, detecting functions, such as working current, working voltage, environment temperature, and so on, of a driver are critically important for the stability of driving systems. Most existing methods only determine if a drive to detect needs to stop working according to detection results, and do not provide adequate information for user to analyze when some of functions of the driver to test are abnormal. Thus, it is difficult via the most existing methods to find reasons of producing the abnormal function parameters, and can not efficiently protect the driver.

What is needed, therefore, is to provide a detecting system and method that can overcome the aforementioned deficiencies.

### BRIEF DESCRIPTION OF THE DRAWINGS

FIG. 1 is a block diagram of an exemplary embodiment of a detecting system for detecting a plurality of functions of a driver.

FIG. 2 is a flowchart of an exemplary embodiment of a detecting method for detecting a plurality of functions of a driver.

### DETAILED DESCRIPTION

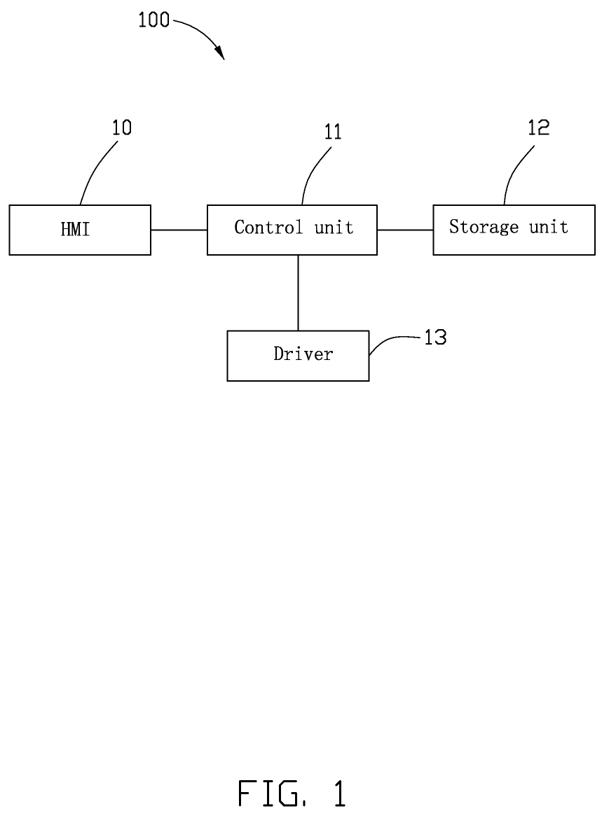

Referring to FIG. 1, an exemplary embodiment of a detecting system 100 for detecting a plurality of functions, such as working current, working voltage, environment temperature, of a driver 13 may include a human machine interface (HMI) 10, a control unit 11 connected to the HMI 10, and a storage unit 12 connected to the control unit 11. When the driver 13 is functioning abnormally, the control unit 11 efficiently protects the driver 13 through controlling the driver 13 to stop working, and transmit a plurality of sample values for the plurality of functions of the driver 13 to the HMI 10 for analysis. Further details of elements and operations of the detecting system 100 will be described as follows.

The HMI 10 is configured for inputting a preset sampling time interval and a preset sampling start time into the control unit 11. In one embodiment, the preset sampling time interval and the preset sampling start time are ten minutes and 9:00 am respectively, for example. The control unit 11 is configured for sampling the plurality of functions of the driver 13 to generate a plurality of sampled values at each sampling time, such as 9:10 am, and 10:00 am, for example. After generating plurality of sampled values, the control unit 11 determines if the plurality of sampled values are normal according to a plurality of preset reference ranges for the plurality of functions. The plurality of preset reference ranges and the plurality of sampled values are stored in the storage unit 12. Each of the plurality of functions has a normal reference range, a caution reference range, and a mistake reference range. In one embodiment, the normal reference range of working current of the driver 13 is [5A, 10A]; the caution reference ranges of working current of the driver 13 are (2A, 5A) and (10A, 12A); the mistake reference ranges of working current of the driver 13 are [0A, 2A] and [12A, ∞), for example. It can be understood that the normal, caution, and mistake reference ranges for the plurality of functions of the driver 13 can be changed according to design needs.

In one embodiment, the control unit 11 generates an alarm signal in response to that one or more of the plurality of sampled values is abnormal. For example, when a sampled working current value for the driver 13 is not in the normal reference range of working current of the driver 13, such as [5A, 10A], the control unit 11 generates an alarm signal, which indicates the control unit 11 to transmit the plurality of sampled values to the HMI 10 to display. More specifically, when the sampled working current value for the driver 13 is in the mistake reference range of working current of the driver 13, such as [0A, 2A] or [12A, ∞), the control unit 11 generates a mistake indication signal which indicates the control unit 11 to control the driver 13 to stop working. Therefore, the detecting system can not only protect the driver but also provide adequate information for user analysis.

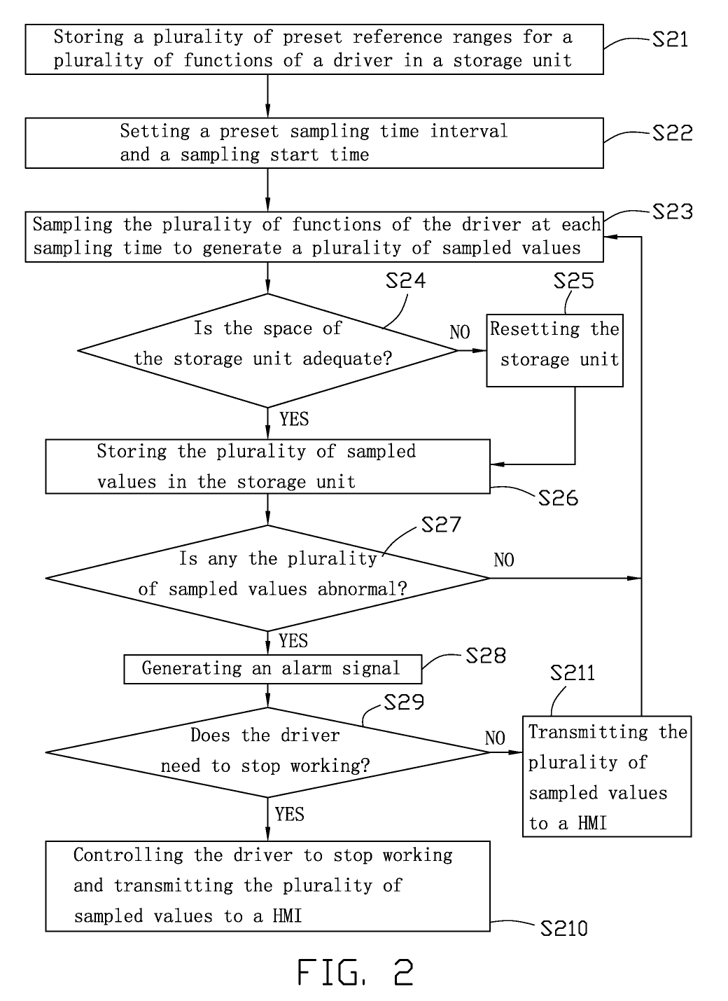

Referring to FIG. 2, an embodiment of a detecting method for detecting a plurality of functions of the driver 13.

In step S21, the storage unit 12 stores a plurality of preset reference ranges for the plurality of functions of the driver 13. In one embodiment, each of the plurality of functions has a normal reference range, a caution reference range, and a mistake reference range.

In step S22, a preset sampling time interval and a sampling start time are inputted through the HMI 10 to the control unit 11. Accordingly, a plurality of sampling time can be determined based on the preset sampling time interval and the preset sampling start time.

In step S23, the control unit 11 controls the driver 13 to work, and samples the plurality of functions of the driver 13 at each of the plurality of sampling time to generate a plurality of sampled values. For example, if the reset sampling time interval and the preset sampling start time are ten minutes and 9:00 am, the control unit 11 samples the plurality of functions of the driver 13 per ten minutes from 9:00 am.

In step S24, the control unit 11 determines if the space of the storage unit 12 is adequate. If the space of the storage unit 12 is adequate, the procedure goes to step S26, otherwise, the procedure goes to step S25.

In step S25, the control unit 11 resets the storage unit 12.

In step S26, the plurality of sampled values are stored in the storage unit 12.

In step S27, the control unit 11 determines if each of the plurality of sampled values is normal according to its corresponding preset reference ranges in the storage unit 12. In one embodiment, if one or more of the plurality of sampled values is not in the normal reference ranges, the procedure goes to step S28. If the plurality of sampled values are in normal reference ranges, the procedure returns to step S23.

In step S28, the control unit 11 generates an alarm signal to indicate that the driver 13 is functioning abnormally.

In step S29, the control unit 11 determines if the abnormal sampling signals are in their corresponding mistake reference ranges. If one or more of the abnormal sampling signals are in their corresponding mistake reference ranges, the control unit 11 generates a mistake indication signal, and the procedure goes to step S210. If none of the abnormal sampling signals is in its corresponding mistake reference ranges, the procedure goes to step S211.

In step S210, the control unit 11 controls the driver 13 to stop working, and transmits the plurality of sampled values to the HMI 10 to display.

In step S211, the control unit 11 transmits the plurality of sampled values to the HMI 10 to display, and the procedure returns to step S23.

The foregoing description of the certain inventive embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skill in the art to which the present disclosure pertains without departing from its spirit and scope. Accordingly, the scope of the present disclosure is defined by the appended claims rather than the foregoing description and the embodiments described therein.

What is claimed is:

1. A detecting system for detecting a plurality of functions of a driver, the detecting system comprising:
a storage unit for storing a plurality of preset reference ranges for the plurality of functions of the driver;
a control unit configured for sampling the plurality of functions of the driver to generate a plurality of sampled values at each preset sampling time, for determining if the plurality of sampled values are normal according to the plurality of preset reference ranges for the plurality of functions, and for generating an alarm signal in response to that one or more of the plurality of sampled values is abnormal; and
a human machine interface configured for inputting the preset sampling time interval and the preset sampling start time to the control unit, and for displaying the plurality of sampled values in response to that one or more of the plurality of sampled values is abnormal.

2. The detecting system of claim 1, wherein the plurality of sampled values for the plurality of functions are stored in the storage unit.

3. The detecting system of claim 1, wherein each of the plurality of functions has a normal reference range, a caution range, and a mistake reference range.

4. The detecting system of claim 3, wherein the alarm signal is generated in response to that sampled values for corresponding one or more of the plurality of functions are in the caution ranges for the corresponding one or more of the plurality of functions, and none of the plurality of sampled values for the plurality of functions is in the mistake ranges for the plurality of functions.

5. The detecting system of claim 1, wherein the control unit further generates a mistake indication signal in response to that sampled values for corresponding one or more of the plurality of functions are in the mistake ranges for the corresponding one or more of the plurality of functions.

6. The detecting system of claim 1, wherein the each preset sampling time is determined according to a preset sampling time interval and a preset sampling start time.

7. A detecting method for detecting a plurality of functions of a driver in a driving system having a control unit, a human machine interface (HMI), and a storage unit, the detecting method comprising:
sampling the plurality of functions of the driver to generate a plurality of sampled values through the control unit at each preset sampling time;
storing the plurality of sampled values in the storage unit, wherein the storage unit stores a plurality of preset reference ranges for the plurality of functions;
determining if the plurality of sampled values are normal according to the plurality of preset reference ranges for the plurality of functions;
generating an alarm signal in response to that one or more of the plurality of sampled values is abnormal; and
displaying the plurality of sampled values through the HMI in response to that one or more of the plurality of sampled values is abnormal.

8. The detecting method of claim 7, wherein before the sampling step, the detecting method further comprises:
transmitting a preset sampling time interval and a preset sampling start time to the control unit for determining the each preset sampling time.

9. The detecting method of claim 7, wherein before the storing step, the detecting method further comprises:
determining if space of the storage unit is adequate;
storing the plurality of sampled values in the storage unit in response to that the space of the storage unit is adequate; and
storing the plurality of sampled values in the storage unit after resetting the storage unit in response to that the space of the storage unit is not adequate.

10. The detecting method of claim 7, wherein each of the plurality of functions has a normal reference range, a caution range, and a mistake reference range.

11. The detecting method of claim 7, wherein the alarm signal is generated in response to that sampled values for corresponding one or more of the plurality of functions are in the caution ranges for the corresponding one or more of the plurality of functions, and none of the plurality of sampled values for the plurality of functions is in the mistake ranges for the plurality of functions.

12. The detecting method of claim 7, further generating a mistake indication signal by the control unit in response to that sampled values for corresponding one or more of the plurality of functions are in the mistake ranges for the corresponding one or more of the plurality of functions.

13. A computer-readable medium (CRM) having stored thereon instructions that applied in a detecting system having a control unit, a human machine interface (HMI), a driver, and a storage unit, when executed by a computer, cause the computer to:
sample a plurality of functions of the driver to generate a plurality of sampled values through the control unit at each preset sampling time;
store the plurality of sampled values in the storage unit, wherein the storage unit stores a plurality of preset reference ranges for the plurality of functions;
determine if the plurality of sampled values are normal according to the plurality of preset reference ranges for the plurality of functions;
generate an alarm signal in response to that one or more of the plurality of sampled values is abnormal; and
display the plurality of sampled values through the HMI in response to that one or more of the plurality of sampled values is abnormal.

14. The CRM of claim 13, wherein before sampling a plurality of functions of the driver, the CRM cause the computer to:
transmit a preset sampling time interval and a preset sampling start time to the control unit for determining the each preset sampling time.

15. The CRM of claim 13, wherein before storing the plurality of sampled values in the storage unit, the CRM cause the computer to:
determine if space of the storage unit is adequate;
store the plurality of sampled values in the storage unit in response to that the space of the storage unit is adequate; and
store the plurality of sampled values in the storage unit after resetting the storage unit in response to that the space of the storage unit is not adequate.

16. The CRM of claim 13, wherein each of the plurality of functions has a normal reference range, a caution range, and a mistake reference range.

17. The CRM of claim 13, wherein the alarm signal is generated in response to that sampled values for corresponding one or more of the plurality of functions are in the caution ranges for the corresponding one or more of the plurality of functions, and none of the plurality of sampled values for the plurality of functions is in the mistake ranges for the plurality of functions.

18. The CRM of claim 13, further causing the computer to:
generate a mistake indication signal by the control unit in response to that sampled values for corresponding one or more of the plurality of functions are in the mistake ranges for the corresponding one or more of the plurality of functions.
